(19) United States
(12) Patent Application Publication
(10) Pub. No.: US 2016/0254542 A1
(43) Pub. Date: Sep. 1, 2016

(54) Cathode Active Material for Lithium Ion Secondary Batteries, and Lithium Ion Secondary Battery

(71) Applicant: HITACHI, LTD., Chiyoda-ku, Tokyo (JP)

(72) Inventors: Hiroaki KONISHI, Tokyo (JP); Akira GUNJI, Tokyo (JP); Tatsuya TOYAMA, Tokyo (JP); Xiaoliang FENG, Tokyo (JP); Sho FURUTSUKI, Tokyo (JP); Toyotaka YUASA, Tokyo (JP); Mitsuru KOBAYASHI, Tokyo (JP); Hisato TOKORO, Tokyo (JP); Shuichi TAKANO, Tokyo (JP); Takashi NAKABAYASHI, Tokyo (JP)

(21) Appl. No.: 15/027,623

(22) PCT Filed: Oct. 23, 2013
(86) PCT No.: PCT/JP2013/078640

§ 371 Date: Apr. 6, 2016

(51) Int. Cl. H01M 4/525; H02J 7/00; H01M 10/46; H01M 10/48; H01M 10/0525; H01M 4/505

(52) U.S. Cl. CPC H01M 4/525; H01M 10/0525; H01M 4/505; H01M 10/46; H01M 10/48; H02J 7/007; H01M 2004/028

(57) ABSTRACT

The objective of the present invention is to provide a lithium ion secondary battery, the charged state of which can be detected from the battery voltage with high accuracy, and which is able to achieve a high capacity in a high-potential range. This objective can be achieved by a cathode active material for lithium ion secondary batteries, which is composed of a lithium transition metal oxide containing Li and metal elements including at least Ni and Mn, and which is characterized in that: the atomic ratio of Li to the metal elements satisfies 1.15<Lil(metal elements)<1.5; the atomic ratio of Ni to Mn satisfies 0.334<Ni/Mn≦1; and the atomic ratio of Ni and Mn to the metal elements satisfies 0.975≦(Ni+Mn)/(metal elements)≦1.

### TECHNICAL FIELD

The present invention relates to a cathode active material for lithium ion secondary batteries, and a lithium ion secondary battery including the cathode active material.

### BACKGROUND ART

In recent years, an electric car in which energy necessary for running is small is drawing expectations owing to prevention of global warming or concern for exhaustion of fossil fuels. However, the electric car poses a problem that an energy density of a driving battery is low, and a running distance per charging is short, and spreading thereof does not progress. Hence, a secondary battery which is inexpensive and has a high energy density has been requested.

A lithium ion secondary battery has an energy density per weight higher than that of a secondary battery of a nickel-hydrogen battery or a lead storage battery. Therefore, an application thereof to an electric car or a power storage system has been expected. However, higher energy densification is needed to meet the demand of the electric car. It is necessary to increase energy densities of a cathode and an anode for realizing the high energy density formation of the battery. It is necessary to increase a capacity and an average discharge potential for increasing the energy density of the cathode.

A Li rich layer-structured cathode material indicated by Li₂MnO₃-LiMO₂ (notation M designates a transition metal element of Co, Ni or the like) is a cathode active material which can expect a high capacity. The Li rich layer-structured cathode material can also be indicated by a composition Li₁₊ₓM₁₋ₓ′O₂ enriching Li of a cathode active material (LiMO₂) of a layer-structured oxide series.

Patent Literature 1 describes a cathode active material characterized in that the cathode active material is configured by a general formula LiₐCoₓNi_{y}Mn_{z}O₂ (a+x+y+z=2), a molar ration of Li for all of transition metal elements Me, Li/Me (a/(x+y+z)), is 1.25 through 1.40, a molar ratio Co/Me(x/(x+y+z)) is 0.020 through 0.230, and a molar ratio Mn/Me(z/(x+y+z)) is 0.625 through 0.719.

Patent Literature 2 describes a cathode active material in which an oxide is coated on a cathode active material which is expressed by a formula Li_{1+b}Ni_{α}Mn_{β}Co_{γ}A_{δ}O₂ (b falls in a range of about 0.05 through about 0.3, α falls in a range of 0 through about 0.4, β falls in a range of 0.2 through about 0.65, γ falls in a range of 0 through about 0.46, δ falls in a range of 0 through about 0.15; however, not both of α and γ are 0, notation A designates Mg, Sr, Ba, Cd, Zn, Al, Ga, B, Zr, Ti, Ca, Ce, Y, Nb, Cr, Fe, V, or combinations of these)

### CITATION LIST

### Patent Literature

Patent Literature 1: Japanese Unexamined Patent Application Publication No. 2012-151084

Patent Literature 2: Japanese Unexamined Patent Application Publication No. 2013-503449

### SUMMARY OF INVENTION

### Technical Problem

A lithium ion secondary battery having a large discharge capacity can be obtained by discharging down to a low potential (2.5 V or lower) by using the cathode active material having the composition described in Patent Literature 1 or 2. However, the lithium ion secondary battery using the cathode active material indicated in Patent Literature 1 or 2 has a hysteresis in an open circuit voltage (OCV). That is, a considerable difference is caused in OCV in the same state of charge between a process of charging from a fully discharged state to a fully charged state, and a process of discharging from the fully charged state to the fully discharged state. It is therefore difficult to detect a state of charge of the battery from the voltage. When an accurate state of charge cannot be detected, an allowance needs to be given to a battery remaining amount in using the battery, and a usable battery capacity is limited.

Further, there arises a problem that in a low potential region, a sufficient power density cannot be obtained even when the capacity is high.

Hence, it is an object of the present invention to provide a lithium ion secondary battery obtaining a high capacity at a high potential and restraining a hysteresis of OCV.

### Solution to Problem

A cathode active material according to the present invention is characterized in that the cathode active material is configured by a lithium transition metal oxide including Li and a metal element, at least Ni and Mn are included as metal elements, an atomic ratio of Li to the metal element is 1.15<Li/metal element<1.5, an atomic ratio of Ni to Mn is 0.334<Ni/Mn≦1, and atomic ratios of the Ni and the Mn to the metal element are 0.975≦(Ni+Mn)/metal element≦1.

### Advantageous Effects of Invention

According to the cathode active material for the lithium ion secondary battery of the present invention, a lithium ion secondary battery obtaining a high capacity at a high potential and restraining a hysteresis of OCV can be provided.

### BRIEF DESCRIPTION OF DRAWINGS

FIG. 1 is a graph showing OCV curves of a first embodiment and a comparative example 1.

FIG. 2 is a graph showing discharge curves of the first embodiment and the comparative example 1.

FIG. 3 is a sectional view schematically showing a structure of a lithium ion secondary battery.

### DESCRIPTION OF EMBODIMENTS

### Cathode Active Material

In a case of adopting a lithium ion secondary battery for an electric car, it is requested that a high energy density is obtained, a running distance per charge is long, and a charged state of the battery is calculated with high accuracy from the voltage.

It is necessary to increase a capacity and an average discharge potential of a battery for obtaining a high energy density. Although the lithium ion secondary battery using the Li rich layer-structured cathode material obtains a high capacity as a cathode active material, a hysteresis is present in OCV, and there poses a problem that it is difficult to detect accurate SOC from the voltage. Here, the Li rich layer-structured cathode material indicates a material which is a lithium transition metal oxide having a rock salt type layer structure, which excessively includes Li for a transition metal, and in which a composition ratio of Mn in the transition metal is equal to or larger than 50%.

In the lithium ion battery, SOC is detected from the voltage. That there is a hysteresis in OCV means that OCV in a charge process and OCV in a discharge process differ from each other in the same SOC. That is, there are two SOC's corresponding to the same potential. In a case where a difference between the two SOC's is large in the same potential, a big error is caused in detecting SOC from OCV. Therefore, when there is a hysteresis in OCV, it is difficult to detect accurate SOC from the battery voltage. Therefore, an allowance needs to be given to a usable battery capacity, and the capacity which can be used as the battery is reduced. Therefore, it is necessary to restrain the hysteresis of OCV for increasing the usable capacity.

As a result of intensive investigation of the inventors, it was found that the high capacity formation and the hysteresis restraint could be made to be compatible with each other by investigating composition ratios of Li, Ni, and Mn in the Li rich layer-structured cathode material.

The Li rich layer-structured cathode material is configured by a rock salt type layer structure, and has a structure in which Li is regularly arranged in the transition metal layer. When a site occupancy rate of a Li layer in a charge process and a rate of including a site of the Li layer in the discharge state were calculated by a molecular dynamics calculation, it was found that the site occupancy rate of the Li layer differed between the charge process and the discharge process. It is inferred that the hysteresis is caused in OCV since energy necessary for moving Li differs when the site occupancy rate of the Li layer differs. Also, in charge and discharge processes, not only Li but Ni move from a transition metal layer to the Li layer. Therefore, it seems that the difference in the site occupancy rate in the charge process and the site occupancy rate of the discharge process can be reduced by increasing the Li/Mn ratio in the cathode active material and increasing the rate of the freely movable element.

Further, in the Li rich layer-structured cathode material, at an initial stage of charge, in the transition metal, a reaction related to a redox is caused, and at a final stage of charge, a redox reaction related to oxygen is caused. On the other hand, in the initial stage of charge, the reaction related to the redox is caused in the transition metal, and at the final stage of discharge, the redox reaction related to oxygen is caused. Although the reaction related to the transition metal is at a high potential, the reaction related to oxygen is at a low potential and a resistance is high. Therefore, a reaction region of the transition metal can be increased and the high potential formation can be carried out by increasing the rate of Ni mainly contributing to the redox reaction in the cathode active material.

Based on the investigation result described above, the cathode active material for the lithium ion secondary battery according to present invention is characterized by being represented by a composition formula LiₓNiₐMn_{b}M_{c}O₂ (0.95≦x<1.2, 0.2<a≦0.4, 0.4≦b<0.6, 0≦c≦0.02, a+b+c=0.8). In the composition formula, it is difficult to specify a composition ratio of oxygen. Therefore, the cathode active material is characterized in that the cathode active material is configured by a lithium transition metal oxide including Li and a metal element, the metal element includes at least Li and Mn, the metal elements includes at least Ni and Mn, atomic ratios of Li, Ni, and Mn satisfy 1.15<Li/metal element<1.5, 0.334<Ni/Mn≦1, 0.975≦(Ni+Mn)/metal element≦1.

Further, the metal element may further include an additional element M. The additional element M is an additional substance or an impurity added in a range of not influencing on the present invention, and at least any element selected from Co, V, Mo, W, Zr, Nb, Ti, Cu, Al, and Fe. It is preferable that the atomic ratio of M to the metal element is 0≦M/metal element≦0.025.

When an atomic ratio of Li (Li/Ni+Mn+M) for metal elements (Ni+Mn+M) in the cathode active material is equal to or less than 1.15, an amount of Li contributing to the reaction is reduced and the high capacity is not obtained. On the other hand, when Li/Ni+Mn+M is larger than 1.5, a crystal lattice is unstable and the discharge capacity is reduced.

When an atomic ratio (Ni/Mn) of Ni for Mn in the cathode active material is equal to or less than 0.334, the contribution of oxygen occupied in the charge and discharge capacity is increased, and a difference between OCV on the charge side and OCV on the discharge side is increased. On the other hand, when Ni/Mn is larger than 1, a valency number of Ni is increased, the charge and discharge capacity related to Ni is reduced, and a high capacity is not obtained.

As described above, the high capacity formation in the high potential (equal to or higher than 3.5 V) region and the hysteresis restraint of OCV can be made compatible with each other by increasing the Ni/Mn ratio of the Li rich layer-structured cathode material of the prior art, and reducing the rate of the Li/metal element. As a result, accuracy in detecting SOC from the battery voltage can be increased, and a usable battery capacity can be increased.

Further, in order to restrain the hysteresis of OCV while maintaining the high capacity, it is preferable that a composition of the cathode active material is LiₓNiₐMn_{b}M_{c}O₂ (0.95≦x≦1.1, 0.30≦a<0.40, 0.40<b≦0.50, 0≦c≦0.02, a+b+c=0.8). That is, it is preferable that atomic ratios of Li, Ni, Mn, and M in the cathode active material satisfy 1.15<Li/(Ni+Mn+M)<1.4, 0.6≦Ni/Mn<1.

According to an embodiment of the present invention, the cathode active material achieves an advantage that cost is lower than that of a cathode active material including much of Co because constituent element other than an oxygen element are mainly configured by Li, Ni, and Mn in the cathode active material.

Although it is preferable that plural primary particles gather to form secondary particles in the cathode active material, the secondary particles may not be formed. It is preferable that a particle diameter of the primary particle is 50 through 300 nm. In the Li rich layer-structured cathode material, an Li ion diffusion coefficient and an electron conductivity are low, and therefore, an electric resistance is higher than that of other cathode active material. When the particle diameter is small, a surface area is large, and therefore, the resistance can be reduced. Also, it is preferable that the particle diameter of the secondary particle is equal to or larger than 1 μm and equal to or smaller than 50 μm.

Further, a tap density of the primary particle of the cathode active material can be increased by making the atomic ratio of Li for the metal element of the cathode active material 1.15<Li/metal element<1.5, making the composition ratio of Mn for Ni 0.334<Ni/Mn≦1. It is preferable that the tap density of the primary particle is equal to or larger than 0.8 g/cm³. When the tap density is high, a volume energy density can be increased. Generally, when the particle diameter is reduced, the tap density tends to be reduced, the tap density can be made to be equal to or larger than 0.8 g/cm³ by making the primary particle diameter equal to or smaller than 300 nm by adjusting the Ni/Mn ratio of the cathode active material. As a result, a lithium ion secondary battery having a low resistance and increasing the volume energy density can be provided.

The cathode active material according to the present invention can be fabricated by a method which is generally used in a technical field to which the present invention pertains. For example, the cathode active material can be fabricated by mixing compounds respectively including Li, Ni, and Mn by pertinent rates and sintering the compounds. A composition of the cathode active material can pertinently be adjusted by changing the rates of mixing the compounds.

Further, when the cathode active material having a small primary particle diameter is synthesized, it is preferable to make the compounds including Li, Ni, and Mn fine by using a ball mill and thereafter, sinter the compounds. A growth of the particle can be restrained by sintering the compounds after making the compounds fine by using the ball mill.

As the compound including Li, for example, lithium acetate, lithium nitrate, lithium carbonate, lithium hydroxide, lithium oxide or the like can be pointed out. As the compound including Ni, for example, nickel acetate, nickel nitrate, nickel carbonate, nickel sulfate, nickel hydroxide or the like can be pointed out. As the compound including Mn, for example, manganese acetate, manganese nitrate, manganese carbonate, manganese sulfate, manganese oxide or the like can be pointed out.

A metal composition of the cathode active material can be determined by an elemental analysis by, for example, an inductively coupled plasma method (ICP) or the like.

<Lithium Ion Secondary Battery>

A lithium ion secondary battery according to the present invention is characterized in including the cathode active material described above. It is possible to provide a lithium ion secondary battery having a large capacity in a region of a high potential (equal to or higher than 3.5 V) and capable of detecting a charge state of the battery from a voltage with high accuracy by using the cathode active material. As a result, a usable battery capacity can be increased. Further, a lithium ion secondary battery having a high volume energy density can be provided by using a cathode active material having a high tap density. The lithium ion secondary battery according to the present invention can preferably be used, for example, in an electric car.

A cathode active material occludes and discharges a lithium ion by charge and discharge. All of lithium ions discharged from the cathode active material do not return to the cathode, and therefore, it is anticipated that a composition of the cathode active material after charge and discharge differs from that before charge and discharge.

For example, when the cathode active material of the Li rich layer-structured cathode material represented by LiMO₂ is used in a potential range of 1.0 through 4.3 V, it is found that a composition ratio of Li becomes about 0.75 in a fully discharged state (2.0 V). When consider similar to a layer-structured compound, it is inferred that also a substance amount of Li after the charge and discharge of the Li rich layer-structured cathode material is reduced by about 20 through 30% in a fully discharged state in comparison with that before the charge and discharge.

Therefore, in a case where a lithium secondary battery is fabricated by using the cathode active material according to the present invention and charged and discharged at 4.6 through 2.5 V, a Li composition ratio in the cathode active material becomes about 0.75 in a fully discharged state (at 2.5 V). Therefore, an atomic ratio of Li for a metal element in the cathode active material satisfies a relationship of 0.90<Li/metal element<1.5.

A lithium ion secondary battery is configured by a cathode including a cathode active material, an anode including an anode material, a separator, an electrolysis solution, an electrolyte, and the like.

The anode material is not particularly limited so far as the anode material is a substance which can occlude and discharge a lithium ion. A substance which is generally used in the lithium ion secondary battery can be used as the anode material. For example, graphite, a lithium alloy or the like can be exemplified.

A separator which is generally used can be used in the lithium ion secondary battery. For example, a fine pore film, a nonwoven fabric or the like made of polyolefin of polypropylene, polyethylene, a copolymer of propylene and ethylene or the like can be exemplified.

As an electrolysis solution and an electrolyte which are generally used in the lithium ion secondary battery can be used. For example, as the electrolysis solution, diethyl carbonate, dimethyl carbonate, ethylene carbonate, propylene carbonate, vinylene carbonate, methyl acetate, ethylmethyl carbonate, methylpropyl carbonate, dimethoxyethane or the like can be exemplified. Further, as the electrolyte, LiClOO₄, LiPF₆, LiBF₄, LiAsF₆, LiSbF₆, LiCF₃SO₃, LiC₄F₉SO₃, LiCF₃CO₂, Li₂C₂F₄(SO₃)₂, LiN(CFSO₂)₂, LiC(CF₃SO₂)₃ or the like can be exemplified.

A lithium ion secondary battery 14 explaining one embodiment of a structure of a lithium ion secondary battery according to the present invention in reference to FIG. 3 includes an electrode group having a cathode 5 coated with a cathode active material on both faces of a collector, an anode 6 coated with an anode material on both faces of a collector, and a separator 7. The cathode and the anode 6 are whirled via the separator 7 to form the electrode group of a whirler. The whirler is inserted to a battery can 8.

The anode 6 is electrically connected to the battery can 8 via an anode lead piece 10. The battery can 8 is attached with an enclosed lid 11 via a packing 12. The cathode 5 is electrically connected to the enclosed lid 11 via a cathode lead piece 9. The whirler is insulated by an insulating plate 13.

Further, the electrode group may not be the whirler shown in FIG. 3, but may be a laminated product laminated with the cathode 5 and the anode 6 via the separator 7.

<Lithium Ion Secondary Battery System>

A battery system according to the present invention is characterized as including the lithium ion secondary battery described above. The lithium ion secondary battery system includes the lithium ion secondary battery, a voltage information acquiring unit for detecting the battery voltage, an arithmetic unit determining a charged state from the voltage, and a battery controller for controlling charge, and discharge based on a charged state. According to the battery system described, charge and discharge can be controlled based on the charged state by determining the charged state from the voltage detected by the voltage information acquiring unit.

The battery system including a lithium ion battery using a cathode active material having a hysteresis in OCV has low accuracy of SOC inferred from the battery voltage, and the control of charge and discharge based on SOC is difficult. In contrast thereto, according to the lithium ion secondary battery system according to the present invention, the lithium secondary battery having high detecting accuracy of SOC is used, and the control based on SOC of the lithium ion secondary battery can be carried out. As a result, stability and reliability of the control are increased, and a capacity which can be used as the battery can be increased.

### EMBODIMENTS

Although a description will be given of the present invention by using embodiments and comparative examples further in details as follows, a technical range of the present invention is not limited thereto.

<Preparation of Cathode Active Material>

A precursor was obtained by mixing lithium carbonate, nickel carbonate, and manganese carbonate by a ball mill. A lithium transition metal oxide was obtained by sintering the obtained precursor at 500° C. for 12 hours in air. The obtained lithium transition metal oxide was pelletized, and then sintered at 850 through 1050° C. for 12 hours in air. Sintered pellets were crushed in an agate mortar and classified by a sieve of 45 μm to thereby make the cathode active material represented by a composition formula of LiₓNiₐMn_{b}M_{c}O₂.

Table 1 shows compositions of cathode active materials used in the respective embodiments and comparative examples. A tap density of a primary particle of the cathode active material was made to be a value dividing a volume of an active substance by a mass after 100 times are counted. Table 1 shows compositions of cathode active materials and tap densities of the respective cathode active materials.

TABLE 1

| | | | | | | | | Tap density of |
|---|---|---|---|---|---|---|---|---|
| | | | | | | | | primary particle |
| | Li (x) | Ni (a) | M (b) | M (c) | M | Li/(Ni + Mn + M) | Ni/Mn | (g/cm³) |
| First Embodiment | 1.0 | 0.35 | 0.45 | — | — | 1.25 | 0.78 | 1.22 |
| Second Embodiment | 0.95 | 0.35 | 0.45 | — | — | 1.19 | 0.78 | 1.18 |
| Third Embodiment | 1.05 | 0.35 | 0.45 | — | — | 1.31 | 0.78 | 1.22 |
| Fourth Embodiment | 1.1 | 0.35 | 0.45 | — | — | 1.38 | 0.78 | 1.16 |
| Fifth Embodiment | 1.15 | 0.35 | 0.45 | — | — | 1.44 | 0.78 | 0.91 |
| Sixth Embodiment | 1.1 | 0.25 | 0.55 | — | — | 1.38 | 0.45 | 0.87 |
| Seventh Embodiment | 1.1 | 0.30 | 0.50 | — | — | 1.38 | 0.6 | 1.02 |
| Eighth Embodiment | 1.1 | 0.40 | 0.40 | — | — | 1.38 | 1 | 1.49 |
| Ninth Embodiment | 1.0 | 0.34 | 0.44 | 0.02 | Co | 1.25 | 0.78 | 1.18 |
| Tenth Embodiment | 1.0 | 0.34 | 0.44 | 0.02 | Al | 1.25 | 0.78 | 1.17 |
| Comparative Example 1 | 1.2 | 0.20 | 0.60 | — | — | 1.5 | 0.33 | 0.73 |
| Comparative Example 2 | 1.1 | 0.20 | 0.60 | — | — | 1.38 | 0.33 | 0.75 |
| Comparative Example 3 | 0.9 | 0.35 | 0.45 | — | — | 1.13 | 0.78 | 1.13 |
| Comparative Example 4 | 1.2 | 0.35 | 0.45 | — | — | 1.5 | 0.78 | 1.22 |
| Comparative Example 5 | 1.1 | 0.45 | 0.35 | — | — | 1.38 | 1.29 | 1.52 |

It is found from Table 1 that tap densities of cathode active materials of the first through tenth embodiments are higher than that of the comparative example 1. This is because the compositions of the cathode active materials of the first through tenth embodiments satisfy 0.334<Ni/Mn≦1. Therefore, it was known that the tap density could be made to be equal to or larger than 0.8 g/cm³ by increasing a content of Ni in the cathode active material. The cathode having the high electrode density can be provided by using the cathode active material having the high tap density, as a result, a capacity per unit volume can be increased. Therefore, the lithium ion secondary battery having a high volume energy density can be provided.

<Preparation of Test Cell>

Fifteen kinds of test cells were fabricated by fabricating cathodes by using 15 kinds of cathode active materials fabricated as described above.

Cathode slurry was fabricated by uniformly mixing cathode active materials, conductors, and binders. The cathode slurry was coated on an aluminum collector foil having a thickness of 20 μm, dried at 120° C., and compressed to form by a press such that the electrode density is 2.2 g/cm³ to thereby obtain the electrode plate. Thereafter, the electrode plate was punched in a shape of a circular disk having a diameter of 15 mm to thereby fabricate the cathode.

The anode was fabricated by using a lithium metal. As a non-aqueous solution, a mixed solvent of ethylene carbonate and dimethyl carbonate having a volume ratios of 1:2 dissolved with LiPF₆ by a concentration of 1.0 mol/L was used.

<Charge and Discharge Measurement>

A charge and a discharge measurement was carried out for 15 kinds of test cells fabricated as described above by using cathode active materials of the respective embodiments and comparative examples.

The charge and discharge measurement was carried out for the test cells by making an upper limit voltage as 4.6 V by a current corresponding to 0.05 C in charging and making a lower limit voltage as 2.5 V by a current corresponding to 0.05 C in discharging. Table 2 shows discharge capacities in a region of 4.6 through 3.5 V obtaining high power density in the respective embodiments and comparative examples.

<OCV Measurement>

In the respective embodiments and comparative examples, a difference between OCV in a charge process and OCV in a discharge process was calculated for 15 kinds of test cells fabricated as described above.

Two cycles of charge and discharge measurements were carried out for test cells by making an upper limit voltage as 4.6 V by a current corresponding to 0.05 C in charging, and making a lower limit voltage as 2.5 V by a current corresponding to 0.05 C in discharging, and a discharge capacity of a second cycle was made to be a rated capacity. Thereafter, a test in which 10% of the rated capacity was charged by a current corresponding to 0.05 C and at standby for five hours was repeated until the rated capacity was reached. A test in which the test cell was charged up to the rated capacity, thereafter, 10% of the rated capacity was discharged, and at standby for five hours was repeated until a fully discharged state was reached. At this occasion, a voltage after five hours was defined as OCV. In this state, a voltage after charging up to 50% of the rated capacity from the fully discharged state and at standby for five hours was defined as OCV in the charge process, and a voltage after discharging down to 50% of the rated capacity from the fully charged state at standby for five hours was defined as OCV in the discharge process. Table 2 shows differences of OCV in the charged process and OCV in the discharge process in the respective embodiments and comparative examples.

TABLE 2

| | | OCV |
|---|---|---|
| | discharge capacity (Ah/kg) | difference (V) |
| First Embodiment | 196 | 0.12 |
| Second Embodiment | 186 | 0.13 |
| Third Embodiment | 195 | 0.12 |
| Fourth Embodiment | 181 | 0.13 |
| Fifth Embodiment | 167 | 0.14 |
| Sixth Embodiment | 168 | 0.19 |
| Seventh Embodiment | 179 | 0.19 |
| Eighth Embodiment | 161 | 0.08 |
| Ninth Embodiment | 185 | 0.13 |
| Tenth Embodiment | 183 | 0.13 |
| Comparative Example 1 | 159 | 0.33 |
| Comparative Example 2 | 138 | 0.32 |
| Comparative Example 3 | 155 | 0.14 |
| Comparative Example 4 | 143 | 0.15 |
| Comparative Example 5 | 152 | 0.06 |

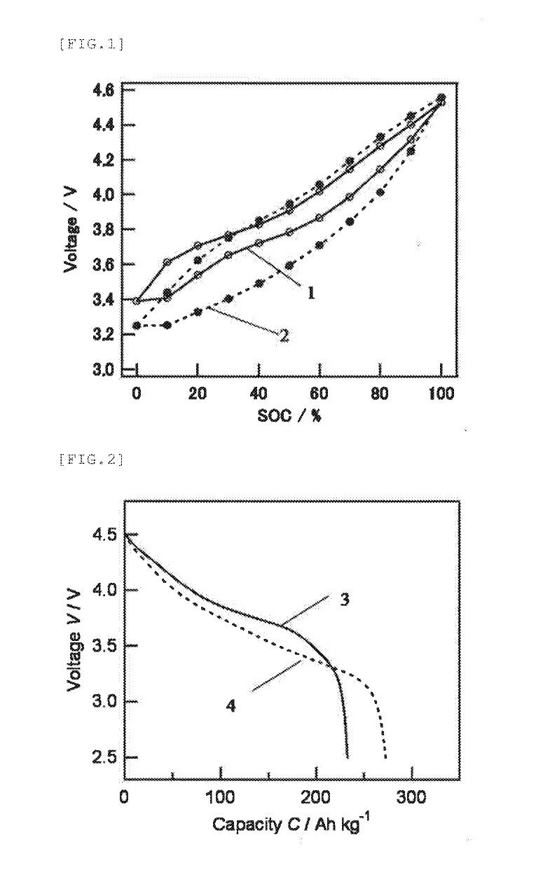

FIG. 1 shows OCV curves of first embodiment and comparative example 1. In FIG. 1, numeral 1 designates an OCV curve of the first embodiment, numeral 2 designates an OCV curve of comparative example L, the ordinate designates OCV (V), and the abscissa designates SOC (%). It is found from FIG. 1 that in the first embodiment, a difference of SOC's at the same OCV is less than 20% at any potential while in comparative example 1, the difference of SOC's at the same OCV is equal to or larger than 20% in a range of OCV of 3.5 through 4.0 V. It is found from this result, that a hysteresis of OCV of the first embodiment is restrained more than that of comparative example 1. Further, also with regard to OCV curves from the second embodiment through the tenth embodiment, similarly to the first embodiment, the difference of SOC at the same OCV was less than 20% in all of potential ranges. Therefore, the lithium ion secondary batteries using the cathode active materials of the first through the tenth embodiments can further accurately detect the remaining capacities of the batteries from the voltages.

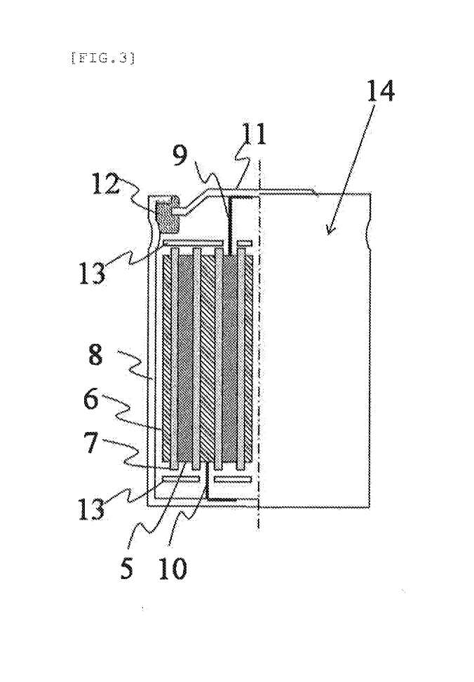

FIG. 2 shows charge and discharge curves of the first embodiment and the comparative example 1. In FIG. 2, numeral 3 designates a charge curve of the first embodiment, and numeral 4 designates the discharge curve of the comparative example 1. It is found that in the first embodiment, a capacity higher than that of the comparative example 1 is obtained in a potential range equal to or higher than 3.5 V. In the first embodiment, a capacity is reduced at a region having a low potential of 2.5 V through 3.0 V. The region is a region which can hardly be used since a sufficient power density is not obtained because of the high resistance. Therefore, when the capacity is high at a high potential (equal to or higher than 3.5 V), an effective capacity, that is, a capacity which can be used as a battery is actually increased. Further, it was found that the high capacity could be obtained in the potential range equal to or higher than 3.5 V similarly to the discharge curve of the embodiment also with regard to the second through the tenth embodiments. As described above, it was found that the capacity was achieved at the high potential and the effective capacity could be increased by using the cathode active materials of the first through the tenth embodiments.

As shown in Table 2, according to the first through the tenth embodiments, the charge capacity is as large as 160 Ah/kg or higher, and a difference between OCV in the charge process and OCV in the discharge process is as small as 0.2 V or lower. On the other hand, in the comparative example 1, the discharge capacity is smaller than those of the first through the tenth embodiments, and a difference between OCV in the charge process and OCV in the discharge process was increased. This is because a composition of the cathode active material of the comparative example 1 is Li/metal element≧1.5, Ni/Mn<0.334.

Further, in the comparative example 2, in comparison with the embodiments, a difference of OCV in the charge process and OCV in the discharge process is large. It seems to be because oxygen mainly contributed to the charge and the discharge reaction since Ni/Mn<0.334. In the comparative examples 3, 4, and 5, the discharge capacities are smaller than those of the embodiments. It seems that the discharge capacity was reduced in the comparative example 3 since Li/metal element<1.15, and Li which could relate to charge and discharge reaction was small. In the comparative example 4, it seems that Li/metal element≧1.5, Li is excessively large, and therefore, the crystal lattice became unstable and the discharge capacity was reduced. In the comparative example 5, it seems that the high capacity was not obtained since Ni/Mn>1, a valency number of Ni was high, the charge and the discharge capacity related by Ni was reduced.

It was found from the result described above that the lithium ion secondary battery having a high charge capacity at high potential and having a small difference between OCV in the charge process and OCV in the discharge process could be provided because the composition of the cathode active material satisfied 1.15<Li/metal element<1.5, 0.334<Ni/Mn≦1, 0.975≦(Ni+Mn)/metal element≦1.

Particularly, in the first embodiment through the fourth, ninth, and tenth embodiments, the discharge capacities are large and OCV differences are small. This is because the composition of the cathode active material fell in a range of 1.15<Li/metal element<1.4 and 0.6<Ni/Mn<1.

Further, even when the additional element M is included as in the ninth and tenth embodiments, so far as 0.975≦(Ni+Mn)/metal element≦1 is satisfied, the lithium ion secondary battery having the large discharge capacity and restraining the hysteresis of OCV can be provided.

As described above, the high discharge capacity can be obtained in the high potential region equal to or higher than 3.5 V and the hysteresis of OCV can be reduced by adjusting the composition of the cathode active material. As a result, an energy density can be increased, and a usable battery capacity is increased. Further, although in the embodiments, the electrode density of the cathode was made to be 2.2 g/cm³, the electrode density can be increased and the capacity per unit volume can be increased by using the cathode material having the high tap density.

### LIST OF REFERENCE SIGNS

1: OCV curve of first embodiment, 2: OCV curve of comparative example 1, 3: discharge curve of first embodiment, 4: discharge curve of comparative example 1, 5: cathode, 6: anode, 7: separator, 8: battery can, 9: cathode lead piece, 10: anode lead piece, 11: enclosed lid, 12: packing, 13: insulating plate, 14: lithium ion secondary battery

1.-16. (canceled)

17. A cathode active material for a lithium ion secondary battery which is a cathode active material including a lithium transition metal oxide including Li and metal elements;
wherein the metal elements include at least Ni and Mn;
wherein the cathode active material is represented by a Composition formula LiₓNiₐMn_{b}M_{c}O₂ (0.95≦x<1.2, 0.2<a≦0.4, 0.4≦b<0.6, 0≦c≦0.02, a+b+c=0.8);
wherein an atomic ratio of the Li to the metal element is 1.15<Li/metal element<1.5;
wherein an atomic ratio of the Ni to the Mn is 0.334<Ni/Mn≦1; and
wherein the atomic ratios of the Ni and the Mn to the metal element are 0.975≦(Ni+Mn)/metal element≦1.

18. The cathode active material for a lithium ion secondary battery according to claim 17;
wherein the cathode active material includes an additional element M as the metal element; and
wherein the M is at least any element selected from Co, Al, V, Mo, W, Zr, Nb, Ti, and Fe.

19. The cathode active material for a lithium ion secondary battery according to claim 17;
wherein the atomic ratio of the Ni to the metal element is Li/metal element<1.4; and
wherein the atomic ratio of the Ni to the Mn is 0.6≦Ni/Mn<1.

20. The cathode active material for a lithium ion secondary battery according to claim 17;
wherein the cathode active material is represented by a Composition formula LiₓNiₐMn_{b}M_{c}O₂ (0.95≦x≦1.1, 0.30≦a<0.40, 0.40<b≦0.50, 0≦c≦0.02, a+b+c=0.8).

21. The cathode active material for a lithium ion secondary battery according to claim 17;
wherein the lithium transition metal oxide includes a primary particle; and
wherein a tap density of the primary particle is equal to or larger than 0.8 g/cm³.

22. A cathode for a lithium ion secondary battery comprising the cathode active material for the lithium ion secondary battery according to claim 17.

23. A lithium ion secondary battery including a cathode including a cathode active material, and an anode including a anode active material;
wherein the cathode active material includes a lithium transition metal oxide including Li and metal elements;
wherein the metal elements include at least Ni and Mn; and
wherein in a fully discharged state after charging and discharging, the cathode active material is represented by a Composition formula LiₓNiₐMn_{b}M_{c}O₂ (0.75≦x<1.2, 0.2<a≦0.4, 0.4≦b<0.6, 0≦c≦0.02, a+b+c=0.8), an atomic ratio of the Li to the metal element is 0.9<Li/metal element<1.5, an atomic ratio of the Ni to the Mn is 0.334<Ni/Mn≦1, and the atomic ratios of the Ni and the Mn to the metal element is 0.975≦(Ni+Mn)/metal element≦1.

24. The lithium ion secondary battery according to claim 23;
wherein the lithium ion secondary battery includes an additional element M as the metal element; and
wherein the M is at least any element selected from Co, Al, V, Mo, W, Zr, Nb, Ti, and Fe.

25. The lithium ion secondary battery according to claim 23;
wherein the atomic ratio of Li to the metal element is Li/metal element<1.4, and the atomic ratio of the Ni to the Mn is 0.6≦Ni/Mn<1.

26. The lithium ion secondary battery according to claim 23;
wherein in the fully discharged state after charging and discharging, the cathode active material is represented by a Composition formula LiₓNiₐMn_{b}M_{c}O₂ (0.75≦x≦1.1, 0.30≦a<0.40, 0.40<b≦0.50, 0≦c≦0.02, a+b+c=0.8).

27. The lithium ion secondary battery according to claim 23;
wherein the lithium ion secondary battery is used at a lower limit voltage equal to or higher than 3.4 V.

28. The lithium ion secondary battery according to claim 23;
wherein a difference between an open circuit voltage at 50% state of charge in charge process and an open circuit voltage at 50% state of charge in discharge process is equal to or smaller than 0.2 V.

29. The lithium ion secondary battery according to claim 23;
wherein a difference between SOC in a charge process and SOC in a discharge process at the same potential is less than 20% in all potential ranges.

30. A lithium ion battery system comprising the lithium ion secondary battery according to claim 23, a voltage information acquiring unit for detecting a battery voltage, an arithmetic unit for determining a charged state from the battery voltage, and a battery controller for controlling charging and discharging based on the charged state.
